(19) United States
(12) Patent Application Publication
(10) Pub. No.: US 2012/0255217 A1
(43) Pub. Date: Oct. 11, 2012

(54) Protective storage insert and system for fishing rods

(76) Inventor: Gregory D. O'Dell, Spring Lake Park, MN (US)

(21) Appl. No.: 13/444,454

(22) Filed: Apr. 11, 2012

Related U.S. Application Data
(60) Provisional application No. 61/474,127, filed on Apr. 11, 2011.

(51) Int. Cl. A01K 97/08

(52) U.S. Cl. 43/26

(57) ABSTRACT

A case and storage system for fishing rods, reels, and tackle comprising a hard sided case and insert. This insert includes a first end, a second end, a reel support member, a first rod support member, and a second rod support member. The first end includes a plurality of notches to support the handle of a fishing pole. The second end includes a groove sized to fit a tackle container. The reel support member includes a plurality of notches to support the handle of a fishing pole and can be alternately spaced with the notches on the first end to allow increased storage. The rod support members include a plurality of notches to support the fishing rod.

### CROSS REFERENCE TO RELATED APPLICATIONS

This application claims the benefit of provisional application Ser. No. 61/474,127 filed on Apr. 11, 2011 to the above named inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to storage cases and systems for storing and transporting fishing rod and reel combinations and tackle. More specifically the system includes an insert specifically designed for insertion into a hard sided case for the storage and protection of fishing rods, reels, and tackle. Storage cases exist in the prior art, however these systems are either contained in a soft sided case or contain an inner foam that easily is penetrated by a fishing hook and provides only minimal protection.

The transport of fishing rods and tackle is an essential part of fishing as individuals often travel to a location to fish that is different from their residence. The typical equipment for fishing includes a fishing rod and reel (typically the most expensive element of the equipment), tackle which includes line, hooks, lures, nets, augers (in the case of ice fishing) and bait. This equipment can cost a significant amount of money and be collected and used over a long period time. Often in transport, the equipment is exposed to damage from contact with other fishing equipment or the elements. Therefore, there exists a need for an improved storage mechanism for fishing rods and tackle.

### SUMMARY OF THE INVENTION

A fishing rod case and storage system is provided for improved protection of fishing rods and reels for storage and transport. The fishing rod case and storage system comprises a hard sided case and insert to securely hold rods, reels, and tackle. The hard sided case provides superior protection from punctures, rips, tears, and other breaches in the integrity of the case when compared to a soft sided case. In the preferred embodiment of the present invention the case is constructed of a molded plastic. Although a plastic is preferred for its cost, durability, and weight, other materials that provide hard protection, such as aluminum, may be used.

In the preferred embodiment of the present invention, the insert is constructed out of a beaded polyethylene that is then laminated for strength and puncture resistance. This material provides significant advantages over standard foam that can be penetrated by fishing lures and hooks. The insert contains strategically placed notches to hold rods and tackle securely.

The fishing rod and tackle carrier according to the present invention includes a hard sided case and a beaded polyethylene insert placed into this hard sided case. The insert contains a first end, a second end, a first rod support member, a second rod support member, a reel support member, and a storage cavity.

The first end defines the first periphery of the insert and includes a plurality of first rod handle notches. The first rod handle notches have a width to accommodate the circumference of a standard fishing rod handle end and a depth that accommodates the height of a standard fishing rod and reel combination, wherein placement of the handle and reel end of a fishing pole into the first rod notch will secure the handle and the reel. The first rod handle notches cannot be too deep as the reel will not be adequately supported or will not properly fit into the case when the insert is installed. In the preferred embodiment of the present invention, the first end contains three (3) rod notches to accommodate a total of three fishing rod handles and reels. The first rod notches are alternately spaced when compared with a plurality of second rod handle notches located on the reel support member, wherein the alternation of the first rod handle notches and the second rod handle notches allow the placement of an increased number of rods.

The second end defines the opposite periphery of the first end of the insert and includes a tackle support groove. The tackle support groove is a groove having a width and length corresponding to the height and length of a standard tackle case, wherein the tackle case can be placed on its edge and inserted snuggly and securely into the groove. In the preferred embodiment of the present invention, the second end includes three (3) support grooves. The number of support grooves can vary depending on the size of the case and the size and number of rods the insert is configured to accommodate.

The reel support member is located interior to the second end and includes the second rod handle notches. The second rod handle notch is similarly shaped to the first rod handle notch. The second rod handle notches have a width to accommodate the circumference of a standard fishing rod handle end and a depth that accommodates the height of a standard fishing rod and reel combination, wherein placement of the handle and reel end of a fishing pole into the second rod handle notches will secure the handle and reel. The second rod handle notches cannot be too deep as the reel will not be adequately supported or will not properly fit into the case when the insert is installed.

The plurality of the second rod handle notches will be alternatively spaced with the first rod handle notches on the first end, wherein the alternation of the first rod handle notches and the second rod handle notches allow the placement of an increased number of rods. In the preferred embodiment of the present invention, the second end contains three (3) second rod handle notches to accommodate a total of three fishing rods and reels and when combined with the capacity of the notches of first end, the case will hold a total of six (6) fishing rods and reels.

The first rod support member contains a plurality of first support grooves and the second rod support member contains a plurality of second support grooves. The first rod support member and the second rod support member are identically configured, wherein the first support grooves and the second support grooves align with each other. The first rod support member is located interior to the first end and in communication with a support wall. The support walls, end, and the first rod support member define a cavity. This cavity provides a void for the insertion of the reel and the handle end of a fishing pole when it is placed into the insert.

The second rod support member is located interior to the reel support member and is in communication with the support walls. The support walls, the rod support member, and the reel support member define a cavity. This cavity provides a void for the insertion of the reel and handle end of a fishing pole when it is placed into the insert.

The storage cavity is configured to receive a standard tackle carrier and is defined at its ends by the first rod storage member and the second rod storage member and on its sides by a set of side supports, wherein the first rod storage member is in communication with the side supports which are in communication with the second rod support member defining a storage cavity. The side supports include a cut out allowing the user to easily remove a tackle carrier that is inserted into the cavity.

Additional configurations of the notches, the sidewalls, and the support members can be arranged to accommodate a varying number of rod and reel combinations and tackle carriers. An additional configuration is disclosed to accommodate larger size fishing poles than the preferred embodiment. In this configuration an additional support member is required to support the longer length of the fishing pole.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 shows a perspective view of the storage insert according to the present invention.

FIG. 1A shows a perspective view of an alternate embodiment of the storage insert according to the present invention.

FIG. 2 shows a top view of the storage insert according to the present invention.

FIG. 2A shows a top view of an alternate embodiment of the storage insert according to the present invention

FIG. 3 shows a side view of the storage insert according to the present invention.

FIG. 3A shows a side view of an alternate embodiment of the storage insert according to the present invention.

### DETAILED DESCRIPTION OF THE INVENTION

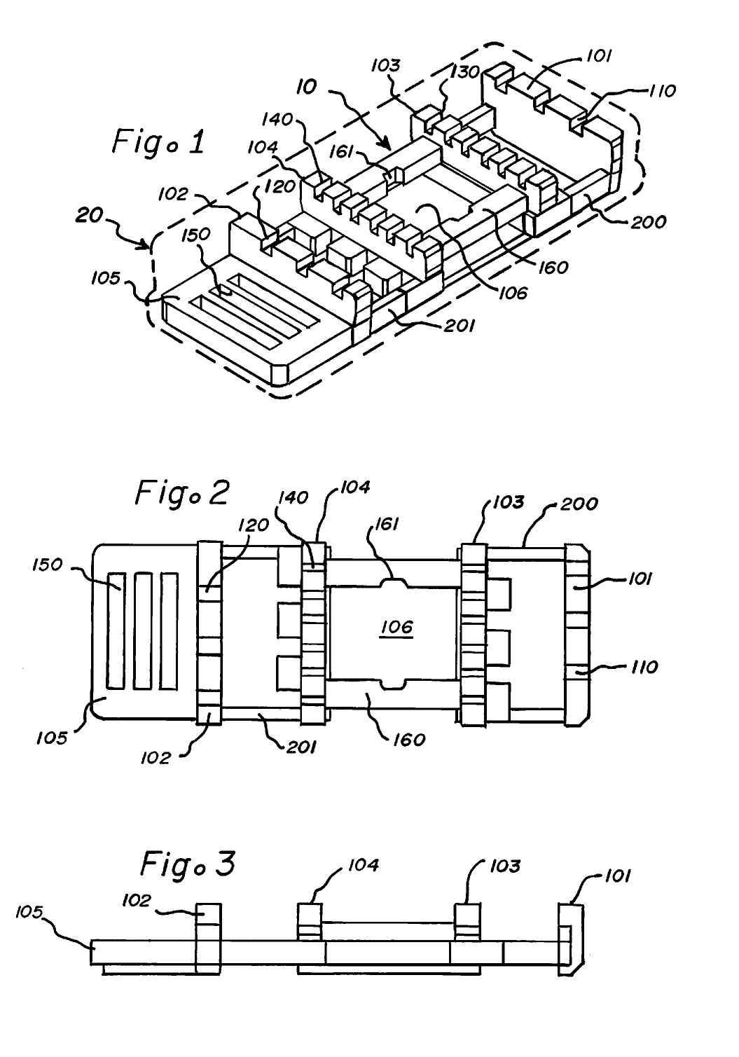

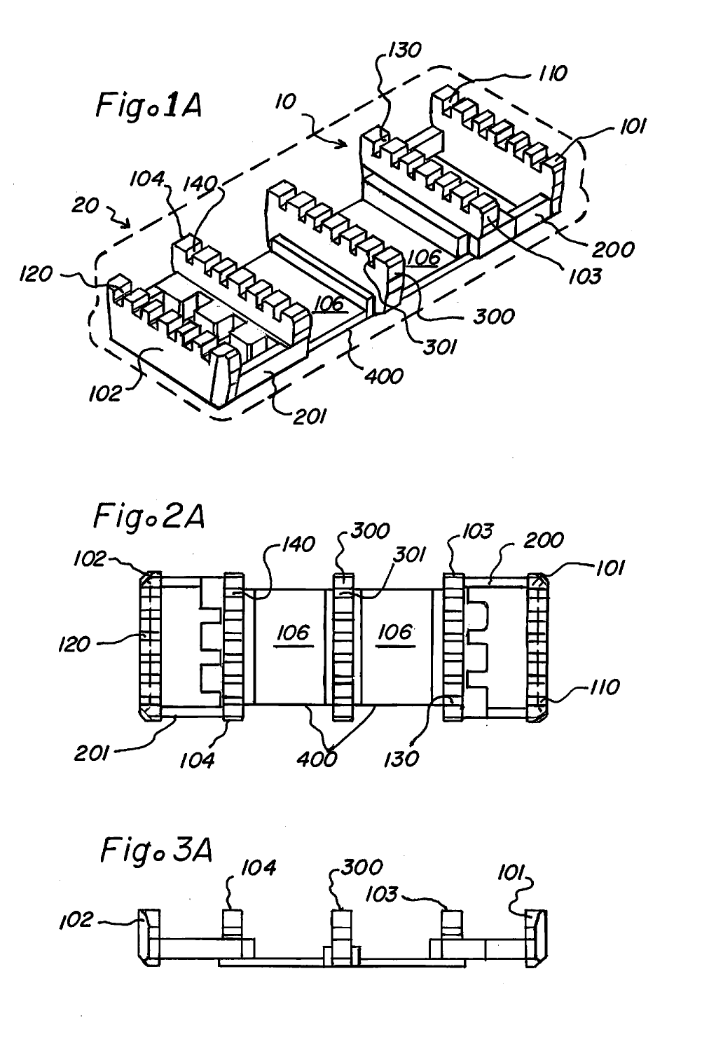

Referring now to FIG. 1-3, a perspective view, top view, and side view of the storage insert according to the present invention, generally referred to as 10 there is shown a first end 101, a second end 105, a first rod support member 103, a second rod support member 104, a reel support member 102, and storage cavity 106. This insert is placed into a hard sided case 20, preferably constructed of a molded plastic and containing a means to securely close and lock the case. Preferably, the insert is constructed out of a beaded polyethylene that is then laminated for strength and puncture resistance. Although a laminated beaded polyethylene is preferred other materials that have similar advantages and properties may be used.

The first end 101 defines the periphery of the insert 10 and includes a plurality of first rod handle notches 110. The first rod handle notches 110 have a width to accommodate the circumference of a standard fishing rod handle end and a depth that accommodates the height of a standard fishing rod reel, wherein placement of the handle and reel end of a fishing pole into the first rod notch 110 will secure the handle and reel. The first rod handle notches 110 cannot be too deep as the reel will not be adequately supported or will not properly fit into the case when the insert 10 is installed. In the preferred embodiment of the present invention, first end 101 contains three (3) first rod handle notches 110 to accommodate a total of three fishing rod handles and reels. The first rod handle notches 110 can be alternately spaced when compared with a plurality of second rod handle notches 120 located on a reel support member 102, wherein the alternation of the first rod handle notches 110 and the second rod handle notches 120 allow the placement of an increased number of rods.

The second end 105 defines the periphery of insert 10 opposite the first end 101 and includes the tackle support groove 150. The tackle support groove 150 is a groove having a width and length corresponding to the height and length of a standard tackle case, wherein the tackle case can be placed on its edge and inserted snuggly and securely into groove 150. In the preferred embodiment of the present invention, the second end 105 includes three (3) support grooves 150. The number of support grooves can vary depending on the size of the case and the size and number of rods the insert 10 is configured to accommodate.

The reel support member 102 is located interior to the second end 105 and includes the plurality of the second rod handle notches 120. The second rod handle notches 120 are similarly shaped to the first rod handle notches 110. The second rod handle notches 120 have a width to accommodate the circumference of a standard fishing rod handle end and a depth that accommodates the height of a standard fishing rod and reel combination, wherein placement of the handle and reel end of a fishing pole into the second rod handle notches 120 will secure the handle and reel. The second rod handle notches 120 cannot be too deep as the reel will not be adequately supported or will not properly fit into the case when the insert 10 is installed.

The second rod handle notches 120 may be alternatively spaced with the first rod handle notches 110 on the first end, wherein the alternation of the first rod handle notches 110 and second rod handle notches 120 allow the placement of an increased number of rods. In the preferred embodiment of the present invention, the reel support member 102 contains three (3) rod notches to accommodate a total of three fishing rods and reels and when combined with the capacity of the notches of first end 101, the case will hold a total of six (6) fishing rods and reels.

The first rod support member 103 contains a plurality of first support grooves 130 and the second rod support member 104 contains plurality of second support grooves 140. The first rod support member 103 and the second rod support member 104 are identically configured, wherein the first support grooves 130 and the second support grooves 140 align with each other. The first rod support member 103 is located interior to the end 101 and in communication with support walls 200. The support walls 200, the first end 101, and the first rod support member 103 define a cavity. This cavity provides a void for the insertion of the reel and handle end of a fishing pole when it is placed into the insert 10.

The second rod support member 104 is located interior to the reel support member 102 and is in communication with support walls 201. The support walls 201, the rod support member 104, and the reel support member 102 define a cavity. This cavity provides a void for the insertion of the reel and handle end of a fishing pole when it is placed into insert 10.

The storage cavity 106 is configured to receive a standard tackle carrier and is defined at its ends by the first rod storage member 103 and the second rod storage member 104 and on its sides by side supports 160, wherein first rod storage member 103 is in communication with side supports 160 which are in communication with the second rod support member 104 and defining a storage cavity 106. The side supports 160 may include a cut out 161 allowing the user to easily remove a tackle carrier that is inserted into the storage cavity 106.

Referring now to FIG. 1A-3A, a perspective view, top view, and side view of an alternate embodiment of the storage insert according to the present invention, generally referred to as 10 there is shown the first end 101, the second end 105, the first rod support member 103, the second rod support member 104, the reel support member 102, the storage cavity 106, and a third rod support member 300. This insert is placed into a hard sided case 20, preferably constructed of a molded plastic and containing a means to securely close and lock the case.

The third rod support member 300 is configured identical to the first rod support member 103 and the second rod support member 104. The third rod support member includes a plurality of third grooves 301. The third support grooves 301 align with the first support grooves 130 and the second support grooves 140. The third rod support member 300 is added to offer additional support to rods that may be longer and requiring additional support and protection.

In this alternate embodiment, the side supports 160 have been removed and a pair of tackle carriers can be placed into the two storage cavities 106 sandwiched in the gaps between the first support member 103 and the third support member 300 and the second support member 104 and third support member 300.

In the preferred embodiment of the present invention, the insert 10 is designed and sized to accommodate six (6) standard ice fishing jigging rods at a length between sixteen (16) and forty (40) inches. To accommodate this length of rods the insert is sized at forty (40) inches long with modifications to the configuration for varying sizes of rods. Additionally, as seen in the preferred embodiment and the alternate embodiment of the present invention, the configuration and design of the storage case and insert can be modified to accommodate various sized rods and reels without modification to the basic system and spirit of the invention.

1. A storage device for fishing rods comprising:
a case; and
a insert sized to fit inside the case, the insert having a first end, a second end opposite the first end, a plurality of first rod handle notches disposed on the first end for receipt of a fishing rod handle and reel assembly, a reel support member opposite the first end interior to the second end, a plurality of second rod handle notches disposed on the reel support member for receipt of a fishing rod handle and reel assembly and alternately spaced with the first rod handle notches, a plurality of rod support members disposed between the first end and the reel support member and having a plurality of grooves for supporting a fishing rod, the rod support members spaced to define a cavity, the cavity sized to receive a tackle case, wherein fishing rods with reels attached are secured within the insert and enclosed within the case for protected transport.

2. The storage device for fishing rods as claimed in claim 1, wherein the second end includes a plurality of grooves having a length and width to accommodate a tackle case, wherein the tackle case is placed onto its edge within the groove for storage and transport within the case.

3. The storage device for fishing rods as claimed in claim 1, wherein the reel support member is the second end of the insert.

4. The storage device for fishing rods as claimed in claim 1, wherein the insert holds six rods and reels.

5. The storage device for fishing rods as claimed in claim 1, wherein the insert holds four tackle cases.

6. The storage device for fishing rods as claimed in claim 1, wherein the case is constructed out of a hard sided case.

7. The storage device for fishing rods as claimed in claim 1, wherein the insert is constructed out of a laminated beaded polyethylene.

8. A storage device for fishing rods comprising:
a hard sided case; and
a insert having a periphery sized to fit inside the case, the insert having a first end at the periphery, a second end opposite the first end, a plurality of first rod handle notches disposed on the first end for receipt of a fishing rod handle and reel assembly, a reel support member opposite the first end interior to the second end, a plurality of second rod handle notches disposed on the reel support member for receipt of a fishing rod handle and reel assembly and alternately spaced with the first rod handle notches, a plurality of rod support members disposed between the first end and the reel support member and having a plurality of grooves for supporting a fishing rod, the rod support members spaced to define a cavity, the cavity sized to receive a tackle case, wherein fishing rods with reels attached are secured within the insert and enclosed within the case for protected transport.

9. The storage device for fishing rods as claimed in claim 8, wherein the second end includes a plurality of grooves having a length and width to accommodate a tackle case, wherein the tackle case is placed onto its edge within the groove for storage and transport within the case.

10. The storage device for fishing rods as claimed in claim 8, wherein the reel support member is the second end of the insert.

11. The storage device for fishing rods as claimed in claim 8, wherein the insert holds six rods and reels.

12. The storage device for fishing rods as claimed in claim 8, wherein the insert holds four tackle cases.

13. The storage device for fishing rods as claimed in claim 8, wherein the insert is constructed out of a laminated beaded polyethylene.

14. A storage device for fishing rods comprising:
a insert removably received within a case, the insert comprising:
a first end;
a second end opposite the first end;
a plurality of first rod handle notches disposed on the first end for receipt of a fishing rod handle and reel assembly;
a reel support member opposite the first end interior to the second end;
a plurality of second rod handle notches alternately spaced with the first rod handle notches and disposed on the reel support member for receipt of a fishing rod handle and reel assembly;
a plurality of rod support members containing grooves for supporting a fishing rod disposed between the first end and the reel support member; and
a cavity sized to receive a tackle case, the cavity defined by the rod support members, wherein fishing rods with reels attached are secured within the insert and enclosed within the case for protected transport.

15. The storage device for fishing rods as claimed in claim 14, wherein the second end includes a plurality of grooves having a length and width to accommodate a tackle case, wherein the tackle case is placed onto its edge within the groove for storage and transport within the case.

16. The storage device for fishing rods as claimed in claim 14, wherein the reel support member is the second end of the insert.

17. The storage device for fishing rods as claimed in claim 14, wherein the insert holds six rods and reels.

18. The storage device for fishing rods as claimed in claim 14, wherein the insert holds four tackle cases.

19. The storage device for fishing rods as claimed in claim 14, wherein the insert is constructed out of a laminated beaded polyethylene.
